(19) United States
(12) Patent Application Publication
(10) Pub. No.: US 2006/0152385 A1
(43) Pub. Date: Jul. 13, 2006

(54) Parking meter

(76) Inventor: Damien Mandy, Fontain (FR)

Correspondence Address: SOFER & HAROUN LLP., 317 MADISON AVENUE, SUITE 910, NEW YORK, NY, 10017, US

(21) Appl. No.: 10/537,714

(22) PCT Filed: Dec. 11, 2003
(86) PCT No.: PCT/FR03/03674

§ 371 Date: Oct. 19, 2005

(30) Foreign Application Priority Data
Dec. 12, 2002 (FR) 02/15882

(51) Int. Cl. G08G 1/14; B60Q 1/48

(52) U.S. Cl. 340/932.2

(57) ABSTRACT

The invention concerns a parking terminal (PK) comprising means for accessing at least one distant server (SV) via a predetermined communication network. The terminal further comprises a short-range communication module designed to converse through short-range radio frequency or short-range infrared channel with that of at least one remote terminal (HH) and routing means adapted to receive data coming from the remote terminal through that same channel (radio frequency or infrared) and to retransmit them to the remote server via the communication network and vice-versa.

The present invention relates to a public parking meter comprising means for accessing a remote server via a predetermined communication network, characterized in that it further comprises a short-range communication module designed to communicate via said communication channel with a short-range communication module of a remote terminal and routing means adapted to receive information from the remote terminal via this communication channel and to route that information to the remote server via the communication network and vice versa.]

It finds an application in chargeable vehicle parking when operatives responsible for chargeable parking dialog with a remote server to exchange information relating to the use of the chargeable parking and/or information intended for users.

At present, operatives responsible for chargeable parking are equipped with remote, mobile, portable and autonomous terminals that have to be connected to a central server to recover and process information and broadcast it to operatives and/or users.

For example, an operative is connected to the central server to recover a parking charge rate, to verify the validity of a parking authorization, to recover information intended for users, to transmit information relating to his activity, such as the beginning and end of his shift, or to transmit information linked to the number of vehicles for which authorization to park has been verified and information relating to parking infringements.

To give another example, maintenance operatives can transmit information relating to operations carried out (replacement of consumables, preventive maintenance report, etc.).

In practice, the central server is a remote server, and so operatives either go to it or effect a connection to it via a communication network such as a GSM mobile communication network.

A method of the above kind is not totally satisfactory because it is costly to implement because of movement of operatives, telephone calls that are chargeable or equipping the remote terminals with modems.

The present invention remedies this drawback.

It relates to a parking meter serving as a public parking terminal comprising means for accessing a remote server via a predetermined communication network.

According to a general definition of the invention, the parking meter further comprises a contactless (for example infra red or radio) communication module adapted to dialog by this kind of communication (hereinafter referred to as “COMM” communication) with a remote terminal and routing means adapted to receive information from the remote terminal via this communication channel and to route that information to the remote server via the communication network and vice versa.

The benefit of “COMM” communication is the ability to communicate without using a telecommunication network and thus without incurring the costs associated with this kind of network.

Accordingly, if an operative or a user wishes to communicate with a server, for example the central server of a chargeable parking system, they dialog with the server by means of “COMM” communication between the remote terminal and the parking meter or via the communication network between the parking meter and the server and vice versa. This kind of parking meter thus allows communication between the terminal and the server without using a chargeable communication network between the terminal and the parking meter and without equipping the terminal with a costly modem.

For example, the access means are adapted to access an Internet Protocol or like communication network.

For example, the “COMM” communication module of the access parking meter is of the IrDA, WiFi or Bluetooth type.

The present invention also consists in an installation of the type comprising a parking meter and a remote terminal belonging to the group comprising portable or fixed computers and personal digital assistants.

The present invention further consists in an installation comprising a remote terminal and a parking meter of the invention.

The present invention further consists in a method of access to a help service of a parking meter of the invention.

According to another aspect of the invention, the method comprises the following steps:

1. equipping the parking meter with a “COMM” communication module (short-range radio, infra red, etc.),

2. equipping a remote terminal with a “COMM” communication module adapted to dialog with that of the parking meter,

3. the parking meter dialoging with the remote terminal via the “COMM” channel and receiving information from the remote terminal via the “COMM” channel and routing it to the remote server via the communication network and vice versa.

Other features and advantages of the invention will become apparent in the light of the following detailed description and the appended drawing, in which the single figure shows by way of non-limiting example a method of accessing a server dedicated to managing a chargeable parking system of the invention.

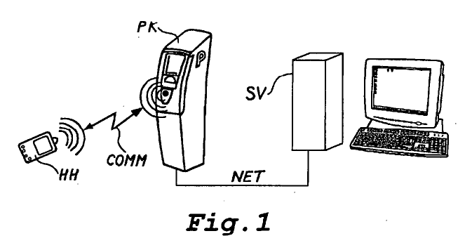

Referring to FIG. 1, the access parking meter PK is a chargeable vehicle parking ticket dispenser.

The ticket dispenser PK is equipped with means for accessing a remote server SV via a communication network NET of the Internet Protocol or similar type. This is known in the art.

For example, the access means comprise an ADSL modem for transmitting data over a symmetrical bit rate digital subscriber line. Any other modem may obviously be suitable for the connection to a communication network.

Other means of accessing the server SV from the terminal PK include an optical fiber network NET or a non-cable telecommunication network NET of the GSM or GPRS type, for example.

In the FIG. 1 example, the ticket dispenser PK comprises a WiFi (802.11b standard) COMM module comprising a transceiver module and an antenna that is adapted to dialog by radio with a remote processing terminal HH equipped with a WiFi module compatible with that of the ticket dispenser.

The ticket dispenser PK comprises processing means adapted to control the WiFi module and to use the access means as a communication relay for the remote processing terminal HH.

For example, these processing means comprise a communication router adapted to receive information emanating from the terminal via the WiFi radio channel and to route it to the server via the communication network and vice versa.

Other short-range communication means enabling exchange of voice and/or data between the remote processing terminal HH and the ticket dispenser PK may be envisaged, for example short-range communication means compatible with the Bluetooth or IrDA protocol.

The remote terminal HH belongs to the group comprising portable or fixed computers, personal digital assistants and the like.

The remote terminal HH and the access parking meter PK are thus equipped with conjugate short-range radio communication means that enable the remote terminal HH to dialog remotely with the remote server SV via the access parking meter PK without the impact of providing the remote terminal HH with means for accessing a specific communication network between the access parking meter PK and the remote terminal HH.

In the case of managing a parking system, the sequence of steps is as follows, for example.

A maintenance operative (or an operative who issues tickets that levy parking fines or other kind of user) arrives in the coverage area of a ticket dispenser with a terminal (portable computer, personal digital assistant) equipped with a radio module compatible with that of the ticket dispenser.

The operative opens a radio session with the parking meter and requests access to a service provided by the central server managing the chargeable parking system, where applicable after access control using a password.

This service may consist in requesting the loading of a file relating to payment for chargeable parking, for example.

In response to the request from the operative, and after validation of access control by the parking meter and/or by the server, the server transmits the requested file via the communication network. The parking meter receives the information emanating from the server via the communication network and relays (routes) it to the terminal via the radio channel.

The remote terminal of the operative is preferably equipped with a connection kit enabling communication with the parking meter. This connection kit may be installed beforehand or downloaded after a payment session using the payment means of the ticket dispenser, for example. Similarly, access to the service can be validated at the end of a payment session using the payment means of the access parking meter.

1. Parking meter comprising:
means for accessing a remote server via a predetermined communication network; and
a short-range communication module adapted to dialog via a short-range radio or infrared channel with a short-range communication module of a remote terminal and routing means adapted to receive information from the remote terminal via this communication channel and to route that information to the remote server via the communication network and vice versa.

2. Parking meter according to claim 1, wherein the access means are adapted to access an Internet Protocol or like communication network.

3. Parking meter according to claim 1, wherein the short-range communication module is of the radio (WiFi or Bluetooth) or infra red (IrDA) type.

4. Installation having comprising a parking meter according to claim 1 and a remote terminal, wherein the remote terminal belongs to the group comprising portable or fixed computers, personal digital assistants and the like.

5. Method of access to a service using a parking meter equipped with means of access to a remote server via a predetermined communication network, said method comprises the following steps:
equipping the parking meter with a short-range communication module
equipping a remote terminal (HH) with a short-range communication module adapted to dialog with that of the parking meter;
conducting a dialog between the parking meter and the remote terminal by short-range communication; and
receiving information from the remote terminal by short-range communication and routing it to the remote server via the communication network and vice versa.
